(19) United States
(12) Patent Application Publication
(10) Pub. No.: US 2026/0228396 A1
(43) Pub. Date: Aug. 6, 2026

(54) PARETO FRONT GENERATION USING DESIGN GENERATIVE MODELS

(71) Applicant: AUTODESK, INC., San Francisco, CA (US)

(72) Inventors: Hyunmin CHEONG, Toronto (CA); Mohammadmehdi ATAEI, Toronto (CA); Amir Hosein KHAS AHMADI, Toronto (CA); Pradeep Kumar JAYARAMAN, Toronto (CA)

(21) Appl. No.: 19/441,667

(22) Filed: Jan. 6, 2026

Related U.S. Application Data
(60) Provisional application No. 63/753,362, filed on Feb. 3, 2025.

(51) Int. Cl. G06F 30/27

(52) U.S. Cl. CPC G06F 30/27

(57) ABSTRACT

One embodiment sets forth a technique for generating design Pareto fronts that includes receiving requirement data; generating, based on a first target requirement included in the requirement data, one or more first perturbed target requirement values generating, based on the requirement data and the one or more first perturbed target requirement values and using one or more machine learning models, one or more first sampled designs; generating, based on the one or more first sampled designs and using a simulator, a first design Pareto front; and performing at least one action based on the first design Pareto front.

### CROSS-REFERENCE TO RELATED APPLICATIONS

This application claims priority benefit of the U.S. Provisional Patent Application titled, “IMPLEMENTING SAMPLING TECHNIQUES WITH GENERATIVE AI MODELS FOR PARETO-FRONT DESIGN EXPLORATION,” filed on Feb. 3, 2025, and having Ser. No. 63/753,362. The subject matter of this related application is hereby incorporated herein by reference

### BACKGROUND

### Technical Field

Embodiments of the present disclosure relate generally to computer-aided design, model-based systems engineering, artificial intelligence, and machine learning, and, more specifically, to techniques for design Pareto front generation using design generative models.

### Description of the Related Art

In practical engineering and design generation, various requirements often compete with one another. A design that satisfies one requirement, such as maximizing structural strength, thermal stability, and/or the like, can conflict with another requirement, such as minimizing weight, cost, power consumption, and/or the like. In one example, in the design of an aircraft wing, increasing stiffness to improve aerodynamic stability can lead to higher material weight. In another example, in automotive engineering, improving crash resistance can increase production cost. In yet another example, optimizing for thermal performance can reduce power efficiency. Because each design candidate performs differently across various requirements, finding a single design solution that optimally satisfies all requirements simultaneously is difficult. Accordingly, designers often need a structured way to understand how improving performance for one requirement impacts performance for other requirements. Design Pareto fronts characterize the trade-off surface across competing requirements. Pareto fronts allow designers to visualize the feasible design space, evaluate competing requirement-performance values objectively, and make balanced decisions based on project priorities or operating conditions.

Conventional approaches for design generation increasingly employ generative modeling techniques in which requirements are used to guide the generation of new design candidates. Conventional approaches for design generation typically begin with the collection of design and simulation data relevant to a particular requirement, followed by subsequent training or fine-tuning of a design generative model. The design generative model learns to represent patterns, constraints, and relationships within the design and simulation data and can generate digital designs, such as geometric models, component assemblies, or parametric configurations, that satisfy the given requirement. When prompted with requirement values, the design generative model generates corresponding design candidates that can be further analyzed, simulated, or refined.

At least one technical drawback of the foregoing approaches is that, under the foregoing approaches, design generative models trained or fine-tuned for a single requirement tend to perform poorly when applied to other requirements. While a design generative model can effectively capture the relationships and constraints associated with a particular requirement, such as aerodynamic efficiency, thermal performance, or structural stiffness, the learned representations are typically specialized for a unique requirement. When the same design generative model is prompted with values corresponding to different requirements, the design generative model often generates designs that fail to satisfy the new requirement specifications or exhibit degraded performance. As a result, separate design generative models are often needed for each requirement, which can limit generalization and increase the computational and data overhead associated with maintaining multiple specialized generative models.

As the foregoing illustrates, what is needed in the art are more effective techniques for design Pareto front generation.

### SUMMARY

One embodiment sets forth a computer-implemented method for generating design Pareto fronts. The method includes receiving requirement data. The method also includes generating, based on a first target requirement included in the requirement data, one or more first perturbed target requirement values. The method further includes generating, based on the requirement data and the one or more first perturbed target requirement values and using one or more machine learning models, one or more first sampled designs. Furthermore, the method includes generating, based on the one or more first sampled designs and using a simulator, a first design Pareto front. In addition, the method includes performing at least one action based on the first design Pareto front.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques enable design exploration across multiple requirements without a requirement to retrain or duplicate separate design generative models. In particular, by varying a target requirement and evaluating resulting designs generated across additional requirements, the disclosed techniques allow each design generative model to remain optimal for the intended requirement while simultaneously supporting multi-requirement analyses. Consequently, the disclosed techniques reduce computational overhead and enhance the ability to identify trade-offs between competing requirements in design generation. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2 is a more detailed illustration of the computing device of FIG. 1, according to various embodiments;

FIG. 3 is a more detailed illustration of the design Pareto front generation application of FIG. 1, according to various embodiments; and

FIG. 4 is a flow diagram of method steps for generating a design Pareto front, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for design Pareto front generation using design generative models. The disclosed techniques include a design Pareto front generation application that uses one or more design generative models to process requirement data and generate a design Pareto front. In some embodiments, the design Pareto front generation application includes a perturbed requirement generator, a design Pareto front generator, a design sampler, and a design simulator. Each of the design generative models is a pretrained or fine-tuned machine learning model, such as a neural network, that processes a target requirement and one or more additional requirements and generate a design. In some embodiments, the perturbed requirement generator processes the target requirement included in the requirement data and generates one or more perturbed target requirement values. The design sampler uses the design generative models to generate one or more sampled designs based on the target requirement, the additional requirements included in the requirement data, and the perturbed target requirement values. The design simulator simulates the sampled designs to generate one or more sampled design performance values. The design Pareto front generator processes the sampled design performance values and the sampled designs and generates the design Pareto front, which includes trade-offs among competing requirements.

The design Pareto front generation techniques of the present disclosure have various real-world applications. For example, the disclosed techniques can be employed in product development and industrial design to analyze competing requirements, such as performance, cost, weight, and durability across mechanical assemblies, electronic systems, or composite materials. In manufacturing, the disclosed techniques can support trade-off exploration during process planning or material selection, thereby allowing engineers to evaluate alternative configurations before production. In aerospace and automotive engineering, design Pareto fronts can guide optimization of structures and components to balance aerodynamic efficiency, structural integrity, and energy consumption. Additionally, the disclosed techniques can be applied in fields such as robotics, architecture, and energy systems to study the relationships between design requirements, identify feasible trade-off solutions, and support data-driven decision-making throughout the design and simulation lifecycle.

The above examples are not in any way intended to be limiting. As persons skilled in the art will appreciate, as a general matter, the design pareto-front generation techniques described herein can be implemented in any suitable application.

### System Overview

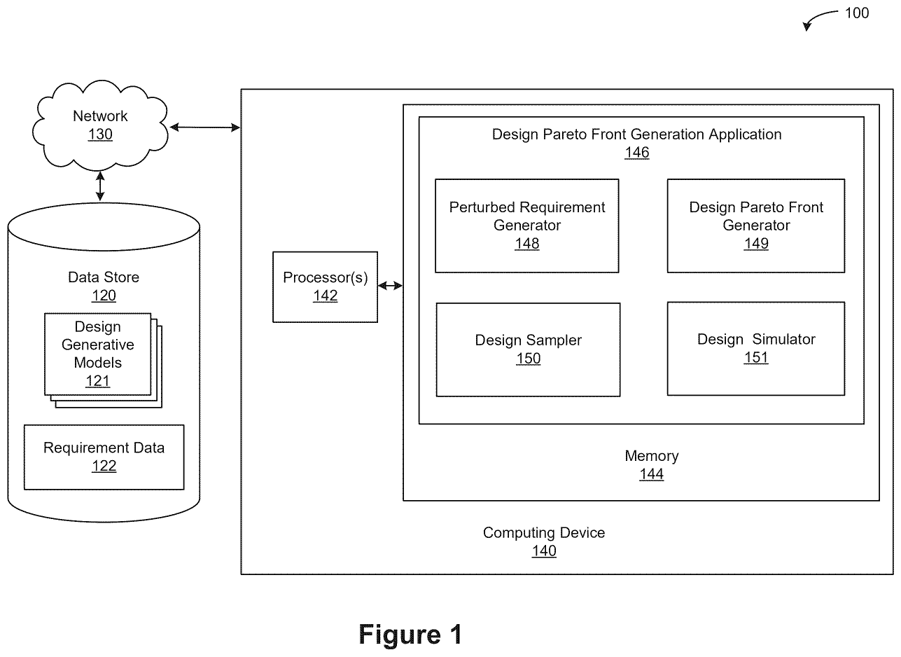

FIG. 1 illustrates a block diagram of a computer-based system 100 configured to implement one or more aspects of at least one embodiment. As shown, system 100 includes a data store 120 and a computing device 140 in communication over a network 130. Network 130 can be a wide area network (WAN) such as the Internet, a local area network (LAN), a cellular network, and/or any other suitable network. Data store 120 includes, without limitation, one or more design generative models 121 and requirement data 122. Computing device 140 includes, without limitation, processor(s) 142 and a memory 144. Memory 144 includes, without limitation, a design Pareto front generation application 146. Design Pareto front generation application 146 includes, without limitation, a perturbed requirement generator 148, a design Pareto front generator 149, a design sampler 150, and a design simulator 151.

Processor(s) 142 receive user input from input devices, such as a keyboard or a mouse. Processor(s) 142 may include one or more primary processors of computing device 140, which control and coordinate operations of other system components. In particular, processor(s) 142 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or similar technologies.

Memory 144 of computing device 140 stores content, such as software applications and data, for use by processor(s) 142 and the GPU(s) and/or other processing units. Memory 144 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the memory 144. The storage can include any number and type of external memories that are accessible to processor 142 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Computing device 140 shown herein is for illustrative purposes only, and variations and modifications are possible without departing from the scope of the present disclosure. For example, the number of processors 142, the number of GPUs and/or other processing unit types, the number of memories 144, and/or the number of applications included in memory 144 can be modified as desired. Further, the connection topology between the various units in FIG. 1 can be modified as desired. In some embodiments, any combination of processor(s) 142, memory 144, and/or GPUs can be included in and/or replaced with any type of virtual computing system, distributed computing system, and/or cloud computing environment, such as a public, private, or hybrid cloud system.

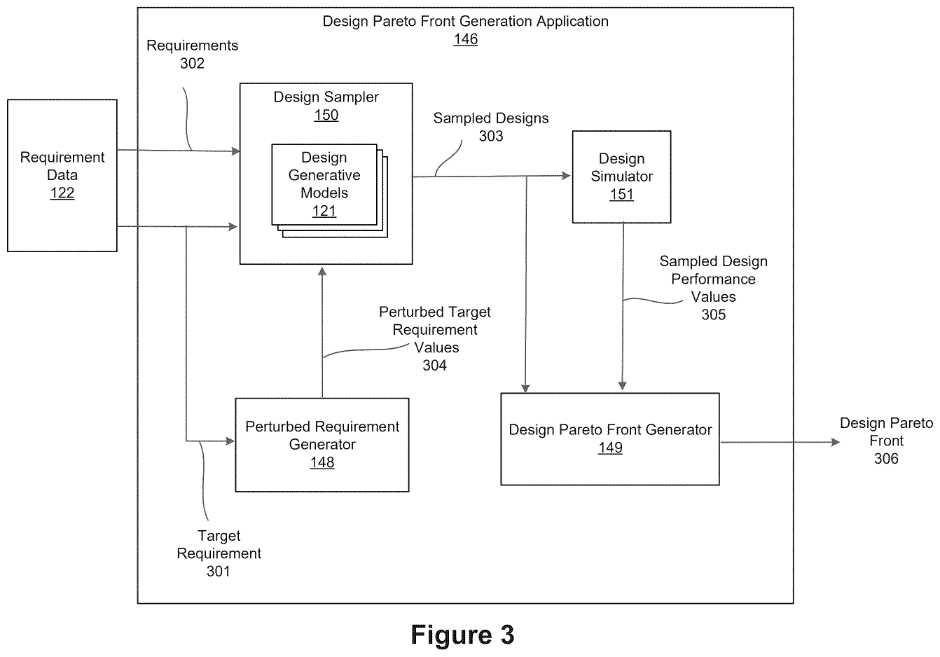

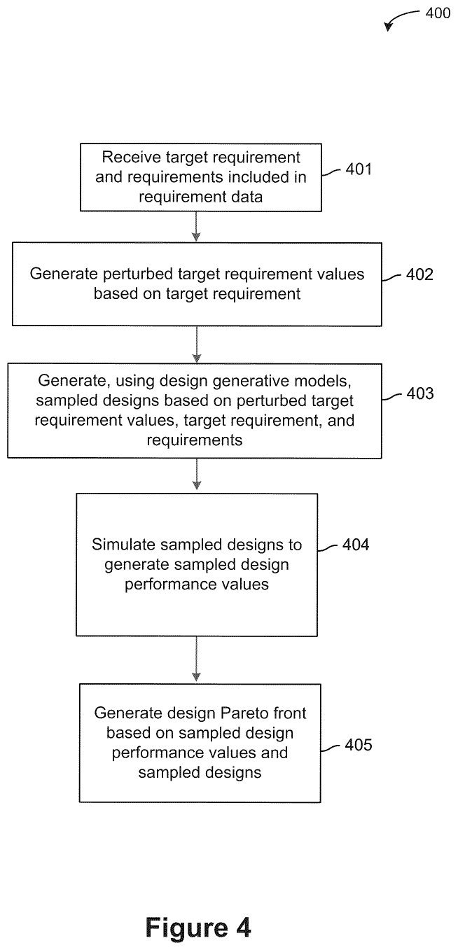

As shown, design Pareto front generation application 146, which uses design generative models 121 stored in data store 120 and accessed over network 130, executes on processor(s) 142 of computing device 140. Design Pareto front generation application 146 uses design generative models 121 to process requirement data 122 and generates a design Pareto front. Design generative models 121 are each a machine learning model, such as a neural network, that processes one or more requirements and generates a design. Requirement data 122 stored in data store 120 includes one or more requirements and corresponding requirement values that define the design objectives and constraints for design generation. In some embodiments, requirement data 122 further includes a target requirement, which represents the particular requirement that is varied or explored during design Pareto front generation, and one or more additional requirements, which remain fixed to provide contextual design boundaries. For example, the target requirement can correspond to a performance-related factor, such as structural strength, aerodynamic efficiency, energy consumption, and/or similar metrics, while the additional requirements can include cost limits, weight targets, material constraints, thermal thresholds, and/or similar parameters. Each requirement is associated with a requirement value that specifies the desired condition for that aspect of the design. The requirement values collectively define the design space within which candidate designs are generated, simulated, and evaluated to construct the resulting design Pareto front. Design Pareto front generation application 146 is discussed in greater detail herein in conjunction with at least FIGS. 3 and 4.

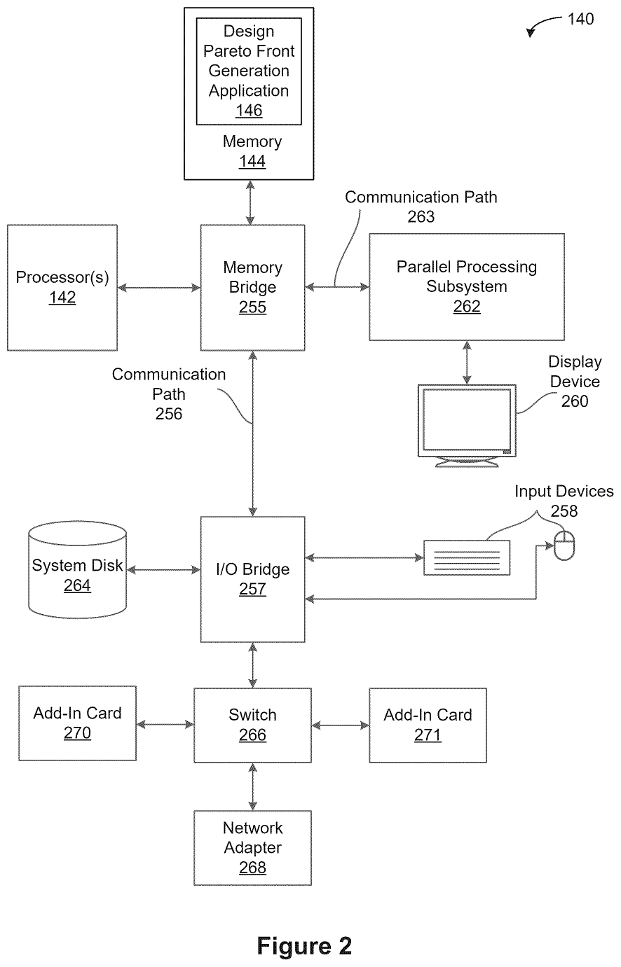

FIG. 2 is a more detailed illustration of computing device 140 of FIG. 1, according to various embodiments. Computing device 140 may include any type of computing system, including, without limitation, a server machine, a server platform, a desktop machine, a laptop machine, a handheld/mobile device, a digital kiosk, an in-vehicle infotainment system, and/or a wearable device. In some embodiments, computing device 140 is a server machine operating in a data center or a cloud computing environment that provides scalable computing resources as a service over a network.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, or sensor data analysis (e.g., evaluating gestures, speech, or other information about one or more users in a field of view or sensory field of one or more sensors), and forward the input information to processor(s) 142 for processing. In some embodiments, computing device 140 may be a server machine in a cloud computing environment. In such embodiments, computing device 140 may not include input devices 258 but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and similar components, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point to point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or similar technologies. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized for general purpose and/or compute processing. Again, such circuitry may be incorporated across one or more PPUs included within parallel processing subsystem 262, which are configured to perform such general-purpose and/or compute operations. In yet other embodiments, the one or more PPUs included within parallel processing subsystem 262 may be configured to perform graphics processing, general-purpose processing, and/or compute processing operations. System memory 144 includes at least one device driver configured to manage the processing operations of the one or more PPUs within parallel processing subsystem 262. In addition, system memory 144 includes design Pareto front generation application 146. Although described herein primarily with respect to design Pareto front generation application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2 to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In some embodiments, one or more components shown in FIG. 2 may not be present. For example, switch 266 could be eliminated, and network adapter 268 and add-in cards 270, 271 would connect directly to I/O bridge 257. Lastly, in some embodiments, one or more components shown in FIG. 2 may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as virtual graphics processing unit(s) (vGPU(s)) that renders graphics on virtual machine(s) (VM(s)) executing on server machine(s) whose GPU(s) and other physical resources are shared across one or more VMs.

### Design Pareto Front Generation Using Design Generative Models

FIG. 3 is a more detailed illustration of product design generation application 146, according to various embodiments. As shown, design Pareto front generation application 146 includes, without limitation, perturbed requirement generator 148, design Pareto front generator 149, design sampler 150, and design simulator 151. Design sampler 150 includes, without limitation, design generative models 121. In operation, perturbed requirement generator 148 processes target requirement 301 included in requirement data 122 and generates perturbed target requirement values 304. Design sampler 150 uses design generative models 121 to generate sampled designs 303 based on target requirement 301, additional requirements 302, and perturbed target requirement values 304. Design simulator 151 simulates sampled designs 303 to generate sampled design performance values 305. Design Pareto front generator 149 processes sampled design performance values 305 and sampled designs 303 and generates design Pareto front 306.

Perturbed requirement generator 148 is an application or a module of design Pareto front generation application 146 that processes target requirement 301 included in requirement data 122 and generates perturbed target requirement values 304. In some embodiments, perturbed requirement generator 148 varies target requirement value associated with target requirement 301 by applying a series of incremental offsets, denoted as E, to explore alternative design outcomes. In some examples, perturbed requirement generator 148 computes each perturbed target requirement value 304 according to rᵢ+εₖ, where rᵢ represents the target requirement value and each εₖ defines a distinct perturbation magnitude. In some embodiments, perturbed requirement generator 148 generates a finite set of K perturbations (e.g., five to ten εₖvalues) spaced within a defined interval around the target requirement value to permit adequate coverage of the local design space. For example, when target requirement 301 corresponds to aerodynamic efficiency, perturbed requirement generator 148 generates perturbed target requirement values 304 representing slightly higher or lower aerodynamic efficiency targets. When target requirement 301 corresponds to structural strength, perturbed requirement generator 148 generates perturbed target requirement values 304 representing incremental increases or decreases in the desired structural strength level. In some embodiments, the perturbations εₖ are spaced uniformly or non-uniformly across the target requirement value. In some embodiments, perturbed requirement generator 148 determines the spacing of perturbed target requirement values 304 adaptively based on observed sensitivities of simulated design performance outcomes. For example, perturbed requirement generator 148 applies smaller perturbations in regions of high-performance gradient and larger perturbations in flatter regions of the requirement space. Adaptive perturbation spacing enables efficient exploration of the requirement space while maintaining adequate resolution near Pareto-optimal boundaries.

Design sampler 150 is an application or a module of design Pareto front generation application 146 that uses design generative models 121 to generate sampled designs 303 based on target requirement 301, additional requirements 302, and perturbed target requirement values 304. Each of design generative models 121 is trained or fine-tuned to generate designs that satisfy a particular requirement. In some embodiments, each design generative model 121 is fine-tuned to be optimal with respect to a corresponding requirement and to generate designs that satisfy the corresponding requirement. In some embodiments, design sampler 150 selects a design generative model 121 associated with target requirement 301 and conditions the design generative model 121 on the corresponding perturbed target requirement values 304 and additional requirements 302. In some examples, for each perturbed target requirement value 304, design sampler 150 computes a sampled design 303 according to

$${D}_{k} = {π}_{θ , {r}_{i}} ( {r}_{i} + {ε}_{k} , {r}_{j \neq i} ) , \qquad ( Equation 1 )$$

where Dₖ represents a sampled design 303, π_{θ,r}_{ᵢ} denotes design generative model 121 fine-tuned for target requirement 301, rᵢ+εₖ is a perturbed target requirement value, and r_{j≠i} are the additional requirements 302. In some embodiments, design sampler 150 iterates over a set of K perturbations to generate a corresponding set of K sampled designs 303. Each sampled design 303 includes a feasible configuration that reflects the trade-offs introduced by varying target requirement 301 while maintaining consistency with the additional requirements 302. In some embodiments, design sampler 150 generates multiple sampled designs 303 per perturbed target requirement value 304 to explore stochastic variations of design generative models 121.

Design simulator 151 simulates sampled designs 303 to generate sampled design performance values 305. In some embodiments, design simulator 151 evaluates each sampled design 303 to determine quantitative performance outcomes. In some embodiments, design simulator 151 receives each sampled design 303 and computes one or more performance metrics included in sampled design performance values 305, such as efficiency, cost, strength, weight, thermal stability, or energy consumption. In some examples, design simulator 151 can use numerical analysis, finite element methods, physics-based modeling, or other domain-specific simulation techniques to estimate how each sampled design 303 performs in real-world conditions. The resulting sampled design performance values 305 quantify the degree to which each sampled design 303 satisfies the target requirement 301.

Design Pareto front generator 149 processes sampled design performance values 305 and sampled designs 303 and generates design Pareto front 306. In some embodiments, design Pareto front generator 149 analyzes sampled design performance values 305 to identify one or more non-dominated designs, where no other design achieves performance that is no worse for all requirements and strictly better for at least one requirement. In some examples, for each sampled design 303 Dₐ with a corresponding performance vector f(Dₐ)=[f₁(Dₐ), f₂(Dₐ), . . . , f_{M}(Dₐ)] included in sampled design performance values 305, design Pareto front generator 149 determines dominance according to Dₐ [symbol] D_{b} if and only if fᵢ(Dₐ)≤fᵢ(D_{b}), ∀i∈{1, . . . , M}, and fⱼ(Dₐ)<fⱼ(D_{b}) for at least one j, where a<b implies a dominates b in pareto sense. A design Dₐ is considered non-dominated if no other design D_{b} satisfies the condition. In some examples, design Pareto front generator 149 collects all non-dominated designs into design Pareto front 306 P*, expressed as P*={Dₐ| [symbol] D_{b}:D_{b} [symbol] Dₐ}. The resulting design Pareto front 306 is the image of P* in performance space, representing the optimal trade-off surface among sampled design performance values 305. In some embodiments, each component fᵢ(Dₐ) is defined so that smaller values indicate better performance and, for originally maximization-type metrics, a monotone transformation, such as negation is applied. For example, in aerodynamic design, design Pareto front 306 can illustrate the balance between lift-to-drag ratio and material weight, while in mechanical systems, design Pareto front 306 can include the trade-off between stiffness and cost. In some embodiments, design Pareto front generation application 146 performs sequential exploration across multiple target requirements 301 included in requirement data 122. Design Pareto front generation application 146 selects each requirement 302 as target requirement 301 in turn while maintaining other requirements 302 as fixed contextual parameters. The process generates a family of design Pareto fronts 306, each corresponding to a different target requirement 301, thereby allowing comprehensive analysis of trade-offs among several competing design requirements included in requirement data 122. In some embodiments, a user can interact with design Pareto front 306 through a graphical interface or analysis tool (not shown) to select a design included in design Pareto front 306 that best aligns with project priorities or operational constraints. For example, the user can choose a design included in design Pareto front 306 emphasizing higher performance at increased cost, or alternatively, a design favoring reduced weight at lower efficiency.

FIG. 4 is a flow diagram of method steps for generating design Pareto front 306, according to various embodiments. Although the method steps are described in conjunction with the systems of FIGS. 1-3, persons skilled in the art will understand that any system configured to perform the method steps in any order falls within the scope of the present embodiments.

As shown, a method 400 begins with step 401, where design sampler 150 receives target requirement 301 and requirements 302 included in requirement data 122 and perturbed requirement generator 148 receives target requirement 301 included in requirement data 122. In some embodiments, requirement data 122 includes one or more requirements and corresponding requirement values that define the design objectives and constraints for design generation. In some embodiments, requirement data 122 further includes target requirement 301, which represents the particular requirement that is varied or explored during design Pareto front generation, and one or more additional requirements 302, which remain fixed to provide contextual design boundaries. Each requirement is associated with a requirement value that specifies the desired condition for that aspect of the design. The requirement values collectively define the design space within which candidate designs are generated, simulated, and evaluated to construct the resulting design Pareto front 306.

At step 402, perturbed requirement generator 148 generates perturbed target requirement values 304 based on target requirement 301. In some embodiments, perturbed requirement generator 148 varies a target requirement value associated with target requirement 301 by applying a series of incremental offsets, denoted as ε, to explore alternative design outcomes. In some examples, perturbed requirement generator 148 computes each perturbed target requirement value 304 according to rᵢ+εₖ, where rᵢ represents the target requirement value and each εₖ defines a distinct perturbation magnitude. In some embodiments, perturbed requirement generator 148 generates a finite set of K perturbations (e.g., five to ten εₖ values) spaced within a defined interval around the target requirement value to permit adequate coverage of the local design space. In some embodiments, the perturbations εₖ are spaced uniformly or non-uniformly across the target requirement value. In some embodiments, perturbed requirement generator 148 determines the spacing of perturbed target requirement values 304 adaptively based on observed sensitivities of simulated design performance outcomes. For example, perturbed requirement generator 148 applies smaller perturbations in regions of high-performance gradient and larger perturbations in flatter regions of the requirement space.

At step 403, design sampler 150 generates, using design generative models 121, sampled designs 303 based on perturbed target requirement values 304, target requirement 301, and requirements 302. In some embodiments, design sampler 150 selects a design generative model 121 associated with target requirement 301 and conditions the design generative model 121 on the corresponding perturbed target requirement values 304 and additional requirements 302. In some examples, for each perturbed target requirement value 304, design sampler 150 computes a sampled design 303 according to Equation 1. In some embodiments, design sampler 150 iterates over a set of K perturbations to generate a corresponding set of K sampled designs 303. Each sampled design 303 includes a feasible configuration that reflects the trade-offs introduced by varying target requirement 301 while maintaining consistency with the additional requirements 302. In some embodiments, design sampler 150 generates multiple sampled designs 303 per perturbed target requirement value 304 to explore stochastic variations of design generative models 121.

At step 404, design simulator 151 simulates sampled designs 303 to generate sampled design performance values 305. In some embodiments, design simulator 151 evaluates each sampled design 303 to determine quantitative performance outcomes. In some embodiments, design simulator 151 receives each sampled design 303 and computes one or more performance metrics included in sampled design performance values 305, such as efficiency, cost, strength, weight, thermal stability, energy consumption, and/or the like. In some examples, design simulator 151 can use numerical analysis, finite element methods, physics-based modeling, or other domain-specific simulation techniques to estimate how each sampled design 303 performs in real-world conditions.

At step 405, design Pareto front generator 149 generates design Pareto front 306 based on sampled design performance values 305 and sampled designs 303. In some embodiments, design Pareto front generator 149 analyzes sampled design performance values 305 to identify one or more non-dominated designs, where no other design achieves performance that is no worse for all requirements and strictly better for at least one requirement. In some examples, for each sampled design 303 Dₐ with a corresponding performance vector f(Dₐ)=[f₁(Dₐ), f₂(Dₐ), . . . , f_{M}(Dₐ)] included in sampled design performance values 305, design Pareto front generator 149 determines dominance according to Dₐ [symbol] D_{b} if and only if fᵢ(Dₐ)≤fᵢ(D_{b}), ∀i∈{1, . . . , M}, and fⱼ(Dₐ)<fⱼ(D_{b}) for at least one j. A design Dₐ is considered non-dominated if no other design D_{b} satisfies the condition. In some examples, design Pareto front generator 149 collects all non-dominated designs into design Pareto front 306 P*, expressed as P*={Dₐ| [symbol] D_{b}:D_{b} [symbol] Dₐ}. The resulting design Pareto front 306 is the image of P* in performance space, representing the optimal trade-off surface among sampled design performance values 305. In some embodiments, each component fᵢ(Dₐ) is defined so that smaller values indicate better performance and, for originally maximization-type metrics, a monotone transformation, such as negation is applied. In some embodiments, design Pareto front generation application 146 performs sequential exploration across multiple target requirements 301 included in requirement data 122. Design Pareto front generation application 146 selects each requirement 302 as target requirement 301 in turn while maintaining other requirements 302 as fixed contextual parameters. The process generates a family of design Pareto fronts 306, each corresponding to a different target requirement 301, thereby allowing comprehensive analysis of trade-offs among several competing design requirements included in requirement data 122. In some embodiments, a user can interact with design Pareto front 306 through a graphical interface or analysis tool (not shown) to select a design included in design Pareto front 306 that best aligns with project priorities or operational constraints.

In sum, techniques are disclosed for design Pareto front generation using design generative models. The disclosed techniques include a design Pareto front generation application that uses one or more design generative models to process requirement data and generate a design Pareto front. In some embodiments, the design Pareto front generation application includes a perturbed requirement generator, a design Pareto front generator, a design sampler, and a design simulator. Design generative models are each a pretrained or fine-tuned machine learning model, such as a neural network, that processes a target requirement and one or more additional requirements and generates a design. In some embodiments, the perturbed requirement generator processes the target requirement included in the requirement data and generates one or more perturbed target requirement values. The design sampler uses the design generative models to generate one or more sampled designs based on the target requirement, the additional requirements included in the requirement data, and the perturbed target requirement values. The design simulator simulates the sampled designs to generate one or more sampled design performance values. The design Pareto front generator processes the sampled design performance values and the sampled designs and generates the design Pareto front that includes trade offs among competing requirements.

At least one technical advantage of the disclosed techniques relative to the prior art is that the disclosed techniques enable design exploration across multiple requirements without a requirement to retrain or duplicate separate design generative models. In particular, by varying a target requirement and evaluating resulting designs generated across additional requirements, the disclosed techniques allow each design generative model to remain optimal for the intended requirement while simultaneously supporting multi-requirement analyses. Consequently, the disclosed techniques reduce computational overhead and enhance the ability to identify trade-offs between competing requirements in design generation.

1. In some embodiments, a computer-implemented method for generating design Pareto fronts includes receiving requirement data, generating, based on a first target requirement included in the requirement data, one or more first perturbed target requirement values, generating, based on the requirement data and the one or more first perturbed target requirement values and using one or more machine learning models, one or more first sampled designs, generating, based on the one or more first sampled designs and using a simulator, a first design Pareto front, and performing at least one action based on the first design Pareto front.

2. The computer-implemented method of clause 1, where at least one machine learning model included in the one or more machine learning models includes a design generative model.

3. The computer-implemented method of clauses 1 or 2, where at least one machine learning model included in the one or more machine learning models is trained to generate a design that satisfies a first requirement included in the requirement data.

4. The computer-implemented method of any of clauses 1-3, where generating the one or more first perturbed target requirement values includes determining a series of incremental offsets to a first target requirement value associated with the first target requirement.

5. The computer-implemented method of any of clauses 1-4, where the series of incremental offsets are spaced uniformly or nonuniformly around the first target requirement value.

6. The computer-implemented method of any of clauses 1-5, where generating the one or more first perturbed target requirement values includes determining, based on one or more simulated design performance outcomes, a spacing between a second perturbed target requirement value included in the one or more first perturbed target requirement values and a third target requirement value included in the one or more first perturbed target requirement values.

7. The computer-implemented method of any of clauses 1-6, where generating the one or more first sampled designs includes selecting, based on the first target requirement, a first machine learning model included in the one or more machine learning models trained to generate a design that satisfies a first target requirement, and generating, based on the requirement data and the one or more first perturbed target requirement values and using the first machine learning model, the one or more first sampled designs.

8. The computer-implemented method of any of clauses 1-7, where generating the first design Pareto front includes simulating, using the simulator, the one or more first sampled designs to generate one or more sampled design performance values, and generating, based on the one or more sampled design performance values and the one or more first sampled designs, the first design Pareto front.

9. The computer-implemented method of any of clauses 1-8, where generating the first design Pareto front includes identifying, based on the one or more sampled design performance values, one or more non-dominated designs.

10. The computer-implemented method of any of clauses 1-9, further including generating, based on a second target requirement included in the requirement data, one or more second perturbed target requirement values, generating, based on the requirement data and the one or more second perturbed target requirement values and using a second machine learning model included in the one or more machine learning models, one or more second sampled designs, and generating, based on the one or more second sampled designs and using the simulator, a second design Pareto front.

11. The computer-implemented method of any of clauses 1-10, further including generating, based on the first design Pareto front and the second design Pareto front, a family of design Pareto fronts.

12. The computer-implemented method of any of clauses 1-11, where performing at least one action includes receiving one or more user inputs via at least one of a graphical interface or an analysis tool, and selecting, based on the one or more user inputs and at least one of one or more project priorities or one or more operational constraints, a design included in the first design Pareto front.

13. The computer-implemented method of any of clauses 1-12, where generating the one or more first sampled designs includes generating, based on the requirement data and a second perturbed target requirement value included in the one or more first perturbed target requirement values and using one or more machine learning models, a plurality of second sampled designs.

14. In some embodiments, one or more non-transitory computer-readable media store instructions that, when executed by one or more processors, cause the one or more processors to perform the steps of receiving requirement data, generating, based on a first target requirement included in the requirement data, one or more first perturbed target requirement values, generating, based on the requirement data and the one or more first perturbed target requirement values and using one or more machine learning models, one or more first sampled designs, generating, based on the one or more first sampled designs and using a simulator, a first design Pareto front, and performing at least one action based on the first design Pareto front.

15. The one or more non-transitory computer-readable media of clause 14, where at least one machine learning model included in the one or more machine learning models is trained to generate a design that satisfies a first requirement included in the requirement data.

16. The one or more non-transitory computer-readable media of clauses 14 or 15, where generating the one or more first perturbed target requirement values includes determining a series of incremental offsets to a first target requirement value associated with the first target requirement.

17. The one or more non-transitory computer-readable media of any of clauses 14-16, where generating the one or more first sampled designs includes selecting, based on the first target requirement, a first machine learning model included in the one or more machine learning models trained to generate a design that satisfies a first target requirement, and generating, based on the requirement data and the one or more first perturbed target requirement values and using the first machine learning model, the one or more first sampled designs.

18. The one or more non-transitory computer-readable media of any of clauses 14-17, where generating the first design Pareto front includes simulating, using the simulator, the one or more first sampled designs to generate one or more sampled design performance values, and generating, based on the one or more sampled design performance values and the one or more first sampled designs, the first design Pareto front.

19. The one or more non-transitory computer-readable media of any of clauses 14-18, where performing at least one action includes receiving one or more user inputs via at least one of a graphical interface or an analysis tool, and selecting, based on the one or more user inputs and at least one of one or more project priorities or one or more operational constraints, a design included in the first design Pareto front.

20. In some embodiments, a system includes one or more memories storing instructions, and one or more processors that are coupled to the one or more memories and, when executing the instructions, are configured to receive requirement data, generate, based on a first target requirement included in the requirement data, one or more first perturbed target requirement values, generate, based on the requirement data and the one or more first perturbed target requirement values and using one or more machine learning models, one or more first sampled designs, generate, based on the one or more first sampled designs and using a simulator, a first design Pareto front, and perform at least one action based on the first design Pareto front.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating design Pareto fronts, the method comprising:
receiving requirement data;
generating, based on a first target requirement included in the requirement data, one or more first perturbed target requirement values;
generating, based on the requirement data and the one or more first perturbed target requirement values and using one or more machine learning models, one or more first sampled designs;
generating, based on the one or more first sampled designs and using a simulator, a first design Pareto front; and
performing at least one action based on the first design Pareto front.

2. The computer-implemented method of claim 1, wherein at least one machine learning model included in the one or more machine learning models comprises a design generative model.

3. The computer-implemented method of claim 1, wherein at least one machine learning model included in the one or more machine learning models is trained to generate a design that satisfies a first requirement included in the requirement data.

4. The computer-implemented method of claim 1, wherein generating the one or more first perturbed target requirement values comprises determining a series of incremental offsets to a first target requirement value associated with the first target requirement.

5. The computer-implemented method of claim 4, wherein the series of incremental offsets are spaced uniformly or nonuniformly around the first target requirement value.

6. The computer-implemented method of claim 1, wherein generating the one or more first perturbed target requirement values comprises determining, based on one or more simulated design performance outcomes, a spacing between a second perturbed target requirement value included in the one or more first perturbed target requirement values and a third target requirement value included in the one or more first perturbed target requirement values.

7. The computer-implemented method of claim 1, wherein generating the one or more first sampled designs comprises:
selecting, based on the first target requirement, a first machine learning model included in the one or more machine learning models trained to generate a design that satisfies a first target requirement; and
generating, based on the requirement data and the one or more first perturbed target requirement values and using the first machine learning model, the one or more first sampled designs.

8. The computer-implemented method of claim 1, wherein generating the first design Pareto front comprises:
simulating, using the simulator, the one or more first sampled designs to generate one or more sampled design performance values; and
generating, based on the one or more sampled design performance values and the one or more first sampled designs, the first design Pareto front.

9. The computer-implemented method of claim 8, wherein generating the first design Pareto front comprises identifying, based on the one or more sampled design performance values, one or more non-dominated designs.

10. The computer-implemented method of claim 1, further comprising:
generating, based on a second target requirement included in the requirement data, one or more second perturbed target requirement values;
generating, based on the requirement data and the one or more second perturbed target requirement values and using a second machine learning model included in the one or more machine learning models, one or more second sampled designs; and
generating, based on the one or more second sampled designs and using the simulator, a second design Pareto front.

11. The computer-implemented method of claim 10, further comprising generating, based on the first design Pareto front and the second design Pareto front, a family of design Pareto fronts.

12. The computer-implemented method of claim 1, wherein performing at least one action comprises:
receiving one or more user inputs via at least one of a graphical interface or an analysis tool; and
selecting, based on the one or more user inputs and at least one of one or more project priorities or one or more operational constraints, a design included in the first design Pareto front.

13. The computer-implemented method of claim 1, wherein generating the one or more first sampled designs comprises generating, based on the requirement data and a second perturbed target requirement value included in the one or more first perturbed target requirement values and using one or more machine learning models, a plurality of second sampled designs.

14. One or more non-transitory computer-readable media storing instructions that, when executed by one or more processors, cause the one or more processors to perform the steps of:
receiving requirement data;
generating, based on a first target requirement included in the requirement data, one or more first perturbed target requirement values;
generating, based on the requirement data and the one or more first perturbed target requirement values and using one or more machine learning models, one or more first sampled designs;
generating, based on the one or more first sampled designs and using a simulator, a first design Pareto front; and
performing at least one action based on the first design Pareto front.

15. The one or more non-transitory computer-readable media of claim 14, wherein at least one machine learning model included in the one or more machine learning models is trained to generate a design that satisfies a first requirement included in the requirement data.

16. The one or more non-transitory computer-readable media of claim 14, wherein generating the one or more first perturbed target requirement values comprises determining a series of incremental offsets to a first target requirement value associated with the first target requirement.

17. The one or more non-transitory computer-readable media of claim 14, wherein generating the one or more first sampled designs comprises:
selecting, based on the first target requirement, a first machine learning model included in the one or more machine learning models trained to generate a design that satisfies a first target requirement; and
generating, based on the requirement data and the one or more first perturbed target requirement values and using the first machine learning model, the one or more first sampled designs.

18. The one or more non-transitory computer-readable media of claim 14, wherein generating the first design Pareto front comprises:
simulating, using the simulator, the one or more first sampled designs to generate one or more sampled design performance values; and
generating, based on the one or more sampled design performance values and the one or more first sampled designs, the first design Pareto front.

19. The one or more non-transitory computer-readable media of claim 14, wherein performing at least one action comprises:
receiving one or more user inputs via at least one of a graphical interface or an analysis tool; and
selecting, based on the one or more user inputs and at least one of one or more project priorities or one or more operational constraints, a design included in the first design Pareto front.

20. A system, comprising:
one or more memories storing instructions; and
one or more processors that are coupled to the one or more memories and, when executing the instructions, are configured to:
receive requirement data;
generate, based on a first target requirement included in the requirement data, one or more first perturbed target requirement values;
generate, based on the requirement data and the one or more first perturbed target requirement values and using one or more machine learning models, one or more first sampled designs;
generate, based on the one or more first sampled designs and using a simulator, a first design Pareto front; and
perform at least one action based on the first design Pareto front.
